(19) United States
(12) Patent Application Publication
(10) Pub. No.: US 2002/0106034 A1
(43) Pub. Date: Aug. 8, 2002

(54) MOBILE RADIO TELECOMMUNICATION SYSTEMS

(76) Inventor: DAVID E. COOPER, SURREY (GB)

Correspondence Address: SUGHRUE MION ZINN MACPEAK & SEAS, 2100 PENNSYLVANIA AVENUE N W, WASHINGTON, DC, 200373213

(21) Appl. No.: 09/195,222

(22) Filed: Nov. 18, 1998

(30) Foreign Application Priority Data
Nov. 20, 1997 (GB) 9724448.7

(51) Int. Cl. H04L 27/04; H04L 27/12

(52) U.S. Cl. 375/299

(57) ABSTRACT

A mobile radio telecommunication system comprises at least one base station and at least one mobile station. The base station includes a radio transmitter which transmits encoded signals for reception and decoding by the mobile station and means for combining a stream of signals for transmission with a delayed version of the same signal stream, the delay being of duration which is an order of magnitude greater than the expected delay spread in the system. The mobile station includes means for reconstructing the original signal stream from the combined signal stream.

### BACKGROUND OF THE INVENTION

1. Field of the Invention

This invention relates to a mobile radio telecommunication system, and in particular, to a mobile radio telephone network.

2. Description of the Related Art

Conventional mobile radio telephone networks make use of terrestrial base stations which are distributed over the coverage area of the network. Mobile stations can find and establish a connection with the nearest base station and provisions are made for a mobile station to be handed over from one base station in the network work to a neighboring base station as the mobile station roams in the coverage area.

As shown in FIG. 1, the network includes a base station 10 and a mobile station 11. Lying between the base station 10 and the mobile station 11 is a reflective object 12 which reflects radio waves towards the mobile station 11. These reflected waves arrive at the mobile station later than direct radiation, so that so-called multi-path interference can occur.

The strength of the radio signals received by a mobile station from its current base station varies in accordance with the distance between the base station and the mobile station, but frequency selective fading can also occur as a result of multipath effects. The degree to which signals are lost as a result of multipath interference depends on the active bandwidth. The narrower the bandwidth of the signals received, the worse the effect. Thus, in the GSM (Group Special Mobile) system, where data is transmitted on relatively narrow band signals, severe effects can result from multipath interference.

The severity of the multipath fading effects has been found to be dependent on the “coherence bandwidth” of the signals. The coherence bandwidth is inversely proportional to the delay spread. In a true Gaussian channel there is theoretically no delay spread, so that the coherence bandwidth is infinite and the channel is not frequency selective. In the GSM system, however, a typical delay spread is 1 μS, and this gives rise to a coherence bandwidth of about 1 MHz. Thus a frequency selective fade typically spans 5 GSM channels. This can lead to severe loss of performance, particularly when an interfering signal which has not suffered fading swamps the desired signal.

### SUMMARY OF THE INVENTION

It is an object of the present invention to provide a mobile telecommunication system in which the problem noted above is alleviated.

In accordance with the invention there is provided a mobile radio telecommunication network including at least one base station and at least one mobile station, the base station including a radio transmitter which transmits encoded signals for reception and decoding by the mobile station, and means for combining a stream of signals for transmission with a delayed version of the same signal streams, the delay being of duration which is an order of magnitude greater than the expected delay spread in the system, and the mobile station including means for reconstructing the original signal stream from the combined signal stream.

For example, in a system based on the current GSM specification, the delay could be of the order of 22 μS, which reduces the coherence bandwidth to about 50 kHz. Frequency selective fading would not then affect equally the whole of the bandwidth of a single GSM channel and every channel would have a better probability of being decoded even if there is multipath interference present.

The above and other objects, features and advantages of the present invention will become apparent from the following description with reference to the accompanying drawings which illustrate examples of the present invention.

### BRIEF DESCRIPTION OF THE DRAWINGS

FIG. 1 is a diagram of a telecommunication network showing the circumstances in which multi-path interference can occur;

FIG. 2 is a block diagram of a base station transmitter architecture incorporating an example of the present invention;

FIG. 3 is a block diagram of a mobile station for use with the base station of FIG. 2; and

FIG. 4 is a block diagram showing the processing steps involved in the mobile station.

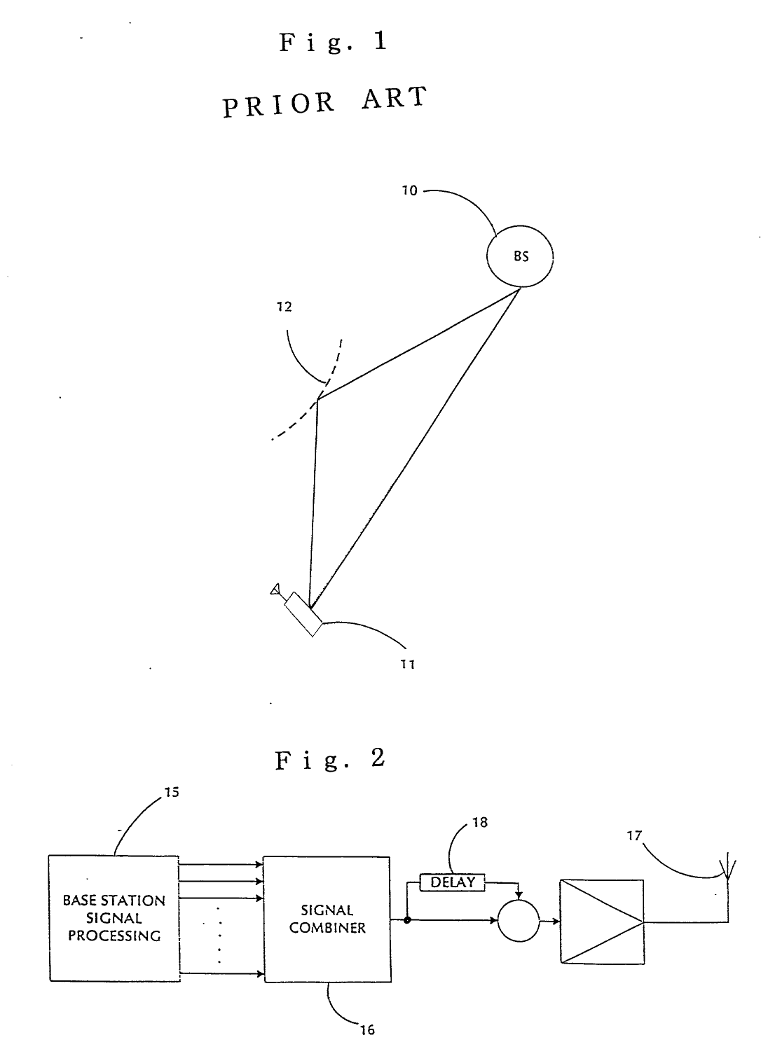

### DETAILED DESCRIPTION OF THE PREFERRED EMBODIMENTS

FIG. 2 shows a base station construction in which output from the various channels of the base station processor 15 are fed to a signal combiner 16 for passing to the transmission antennae 17 of the base station. However, instead of the combined signal train being passed directly to the antennae, as is conventional, the combined signal train is first processed by adding to it a time delayed version of the combined signal. The delay circuit 18 may introduce a delay of, say 22 μLS for a typical GSM system. The delayed version of the signal train is preferably attenuated, so that the signal train which is actually broadcast can be represented by the expression:

T(t)=C(t)+K×C(t−Δ) (0<K≦1)

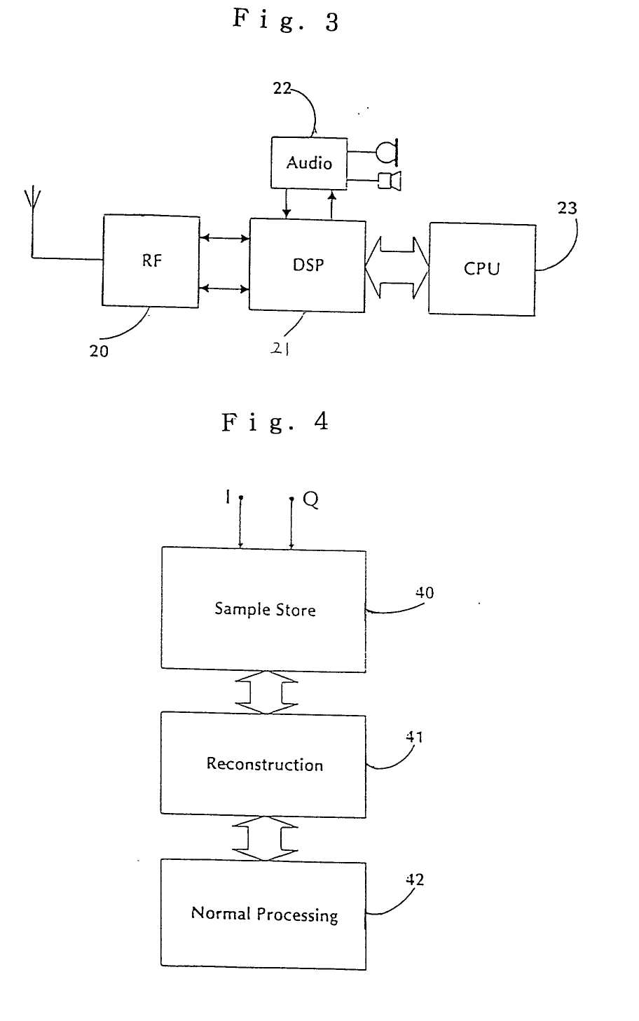

The basic structure of the mobile station is shown in FIG. 3. This shows an RF stage 20 which passes to a digital signal processor (DSP) 21 a stream of sample (I, Q) pairs at a multiple of the symbol rate. These sample pairs are stored in the DSP 21 and processed to generate audio and control signals which are passed to an audio stage 22 and a CPU 23 respectively. In the present case, the first stage of the processing involves reconstructing the original signal stream C(t) from the samples. The reconstruction is accomplished by applying to the samples the inverse of the process which was applied in the base station. Thus the reconstruction process 41 (FIG. 4) draws data from the sample store 40 of the DSP 21, processes it to obtain the original C(t) values and passes the reconstructed signals on for normal processing 42.

While a preferred embodiment of the present invention has been described using specific terms, such description is for illustrative purposes only, and it is to be understood that changes and variations may be made without departing from the spirit or scope of the following claims.

What is claimed is:

1. A mobile radio telecommunication system comprising at least one base station and at least one mobile station, the base station including a radio transmitter which transmits encoded signals for reception and decoding by the mobile station and means for combining a stream of signals for transmission with a delayed version of the same signal stream, the delay being of duration which is an order of magnitude greater than the expected delay spread in the system, and the mobile station including means for reconstructing the original signal stream from the combined signal stream.

2. A mobile radio telecommunication system as claimed in claim 1 in which the delayed version of the signal stream is attenuated before being combined with original signal stream.
